(19) United States
(12) Patent Application Publication
(10) Pub. No.: US 2023/0408062 A1
(43) Pub. Date: Dec. 21, 2023

(54) LIGHTING DEVICE

(71) Applicant: Panasonic Intellectual Property Management Co., Ltd., Osaka (JP)

(72) Inventor: Katsuyoshi MASUDA, Fukui (JP)

(21) Appl. No.: 18/458,894

(22) Filed: Aug. 30, 2023

Related U.S. Application Data
(63) Continuation of application No. PCT/JP2021/044873, filed on Dec. 7, 2021.

(30) Foreign Application Priority Data
Mar. 9, 2021 (JP) 2021-037617

(51) Int. Cl. F21V 5/00; B60Q 3/283; B60Q 3/64; B60K 35/00

(52) U.S. Cl. CPC F21V 5/00; B60Q 3/283; B60Q 3/64; B60K 35/00; B60K 2370/128

(57) ABSTRACT

A lighting device includes: a light source; and a display part that displays a first design on a front-side surface by transmitting, in a shape of the first design, light emitted by the light source. The display part includes: a front-side part including the front-side surface and a first portion that transmits light in the shape of the first design; and a light guide that is located behind the front-side part and transmits the light from the light source toward the front-side part, the light source is located at a position different from the first portion, the light guide includes a portion having a thickness that decreases with distance from the light source, and a protrusion including a light incidence surface on which the light from the light source is incident at an incident angle of a predetermined angle is provided on a back-side surface of the light guide.

### CROSS REFERENCE TO RELATED APPLICATION

This is a continuation application of PCT International Application No. PCT/JP2021/044873 filed on Dec. 7, 2021, designating the United States of America, which is based on and claims priority of Japanese Patent Application No. 2021-037617 filed on Mar. 9, 2021.

### FIELD

The present disclosure relates to a lighting device.

### BACKGROUND

Patent Literature (PTL) 1 discloses a button lighting device that includes an illuminated surface having an uneven thickness in a spatial path direction connecting the illuminated surface and a light source located behind the illuminated surface. In the button lighting device, luminance unevenness in a “light-transmissive character” (i.e., design) displayed on the illuminated surface is reduced by causing the thickness of the illuminated surface to decrease with distance from the light source.

### CITATION LIST

### Patent Literature

PTL 1: Japanese Unexamined Utility Model (Registration) Application Publication No. H06-028950

### SUMMARY

However, a lighting device such as the button lighting device described in PTL 1 can be improved upon.

The present disclosure provides a lighting device that is capable of improving upon the above related art.

A lighting device according to an aspect of the present disclosure includes: a light source; and a display part that displays a first design on a front-side surface of the display part by transmitting light forward in a shape of the first design, the light being emitted by the light source, wherein the display part includes: a front-side part that includes the front-side surface and a first portion that transmits light in the shape of the first design; and a light guide that is located behind the front-side part and transmits the light from the light source toward the front-side part, the light source is located at a position different from the first portion of the front-side part in a plan view of the front-side surface, the light guide includes a portion that is located at a position different from the light source and overlapping with the first portion of the front-side part in the plan view of the front-side surface, the portion has a thickness that decreases with distance from the light source, and the light guide includes, on a back-side surface of the portion having the thickness that decreases with distance from the light source, a protrusion including a light incidence surface on which the light from the light source is incident at an incident angle that is a predetermined angle.

The lighting device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates an example of a cabin of a vehicle in which a steering input device according to an embodiment is provided.

FIG. 2 illustrates a usage example of the steering input device according to the embodiment.

FIG. 3 is a plan view of a lighting device according to the embodiment as a front-side surface of the lighting device is viewed in a plan view.

FIG. 4 is a cross-sectional view along IV-IV of part of the lighting device according to the embodiment in FIG. 3.

FIG. 5 is a cross-sectional view along V-V of part of the lighting device according to the embodiment in FIG. 3.

FIG. 6 is a diagram for describing a movement of a display part when a user pushes one of first portions.

FIG. 7 is a diagram for describing a movement of the display part when a user pushes the other of the first portions.

FIG. 8 is an enlarged view of part of a protruding part in FIG. 4.

FIG. 9 is a graph showing a relationship between transmittance of light through a light guide having a refractive index of 1.5 and incident angle.

FIG. 10 is a graph showing a relationship between transmittance of light through the light guide having a refractive index of 1.5 and incident angle with respect to a light incidence surface of the light guide.

FIG. 11 is a graph showing a relationship between distance from a light source and transmittance of light through a light guide in a conventional configuration without a protrusion, and a relationship between distance from a light source and transmittance of light through a light guide in the configuration of the present disclosure with protrusions.

FIG. 12 is a graph showing a relationship between distance from the light source and diffusion distance of light in the light guide in the conventional configuration without a protrusion, and a relationship between distance from the light source and diffusion distance of light in the light guide in the configuration of the present disclosure with protrusions.

FIG. 13 illustrates a luminance distribution on a front-side surface of the light guide in the conventional configuration without a protrusion and a luminance distribution on a front-side surface of the light guide in the configuration of the present disclosure with protrusions.

FIG. 14 is a graph showing a relationship between distance from the light source and luminance on the front-side surface of the light guide in the conventional configuration without a protrusion, and a relationship between distance from the light source and luminance on the front-side surface of the light guide in the configuration of the present disclosure with protrusions.

FIG. 15 is an enlarged view of part of a part, which corresponds to the protruding part in FIG. 4, of display part of a lighting device according to a variation.

### DESCRIPTION OF EMBODIMENT

(Underlying Knowledge Forming Basis of the Present Disclosure) In a button lighting device according to PTL 1, a lamp as a light source is located at a position offset from the center of a button including an illuminated surface in a plan view of the front side of the illuminated surface. In other words, most of the light illuminating a “light-transmissive character” displayed on the front side of the illuminated surface is emitted diagonally to the back side of the illuminated surface. Therefore, on the back side of the illuminated surface, the incident angle of the light emitted, from the light source, diagonally to the back side of the illuminated surface is larger than that of the light emitted, from the light source, in a direction perpendicular to the back side of the illuminated surface. In particular, light is incident at a larger angle on a farther position from the light source.

Since light becomes more likely to be reflected off the back side of the illuminated surface with an increase in incident angle on the back side of the illuminated surface, an amount of light that enters the illuminated surface decreases with an increase in distance from the light source. Therefore, luminance varies according to distance from the light source.

Moreover, a refraction angle of light becomes larger as an incident angle of light becomes larger. Since the light that has entered the illuminated surface is refracted so that the light is transmitted in a direction inclined to a direction perpendicular to the front side of the illuminated surface, light having a smaller incident angle is refracted in a direction closer to the direction perpendicular to the front side of the illuminated surface. Accordingly, the light that has entered the illuminated surface exits from the illuminated surface without being sufficiently diffused inside the illuminated surface. Thus, since the light exits from the illuminated surface more intensively at a position closer to the light source, luminance unevenness occurs.

As described above, even when the illuminated surface has a thickness that decreases with distance from the light source in a configuration in which most of the light illuminating the illuminated surface is emitted diagonally, luminance unevenness cannot be sufficiently reduced. In fact, causing the thickness of the illuminated surface to decrease with distance from the light source tends to result in increasing an incident angle of light incident on the back side of the illuminated surface, and therefore luminance unevenness occurs.

Accordingly, the present disclosure provides a lighting device that can effectively reduce luminance unevenness in a design.

A lighting device according to an aspect of the present disclosure includes: a light source; and a display part that displays a first design on a front-side surface of the display part by transmitting, in a shape of the first design, light emitted by the light source forward. The display part includes: a front-side part that includes the front-side surface and a first portion that transmits light in the shape of the first design; and a light guide that is located behind the front-side part and transmits the light from the light source toward the front-side part, the light source is located at a position different from the first portion of the front-side part in a plan view of the front-side surface, the light guide includes a portion that is located at a position different from the light source and overlapping with the first portion of the front-side part in the plan view of the front-side surface, the portion has a thickness that decreases with distance from the light source, and the light guide includes, on a back-side surface of the portion having the thickness that decreases with distance from the light source, a protrusion including a light incidence surface on which the light from the light source is incident at an incident angle that is a predetermined angle.

Accordingly, since the protrusion is provided on the back-side surface of the light guide, the incident angle of the light incident on the surface of the protrusion on the back side of the light guide can be smaller than that of the light incident on a surface other than the surface of the protrusion on the back side of the light guide. Therefore, the amount of light that is reflected off the back side of the light guide can be reduced, and the amount of light that enters the light guide can be uniformed regardless of distance from the light source. Moreover, since the light that has entered the light guide is refracted at a small angle with respect to the front-side surface of the light guide, the light that has entered the light guide becomes more likely to be diffused in the light guide. Accordingly, the light transmitted from the light guide to the front-side part can be prevented from being transmitted more intensively at a position closer to the light source. Therefore, luminance unevenness in the design can be effectively reduced.

The predetermined angle may be less than or equal to one half of a Brewster angle that is defined by a refractive index of the light guide and a refractive index of a medium around the light guide.

Accordingly, the light emitted to the light guide can efficiently enter the light guide.

The protrusion may be in a shape extending in a direction intersecting a direction connecting the light source and the first portion.

Accordingly, the light emitted to the light guide can efficiently enter the light guide from the light incidence surface having the length of a rib shape.

The light guide may include, on the back-side surface, a plurality of protrusions disposed at positions different in distance from the light source, each of the plurality of protrusions being the protrusion.

Accordingly, even if the size of each of the plurality of protrusions is small, a light incidence surface on which light is incident at a predetermined angle can be provided to each of the plurality of protrusions in a wide area of the back-side surface of the light guide. Thus, the lighting device can be made small.

The plurality of protrusions may include a first protrusion and a second protrusion that is located farther from the light source than the first protrusion is, and a first angle of a first light incidence surface of the first protrusion with respect to the front-side surface may be smaller than a second angle of a second light incidence surface of the second protrusion with respect to the front-side surface.

Accordingly, the light emitted from the light source can efficiently enter the light guide.

Moreover, the plurality of protrusions may be arranged at a predetermined pitch.

Furthermore, the plurality of protrusions may be continuously arranged adjacent to one another.

Furthermore, the predetermined pitch between the plurality of protrusions may vary according to distance from the light source.

Furthermore, the predetermined pitch between the plurality of protrusions may increase with distance from the light source.

Furthermore, the light guide may include a protruding part protruding backward, the protruding part may be located behind the first portion of the front-side part, the protruding part may have a thickness that decreases with distance from the light source, and the protruding part may include, on a back-side surface of the protruding part, the protrusion including the light incidence surface on which the light from the light source is incident at the incident angle that is the predetermined angle.

The front-side part may further include a second portion that transmits light in a shape of a second design, and the light source may be located at a position overlapping with the second portion of the front-side part in the plan view of the front-side surface.

Accordingly, luminance unevenness that is likely to occur in the first design can be effectively reduced.

Moreover, the first portion of the front-side part may include a third portion and a fourth portion, and the light source may be located at a position different from the third portion and the fourth portion of the front-side part in the plan view of the front-side surface.

### EMBODIMENT

### 1. Configuration

### (1-1. Configuration of Steering Input Device)

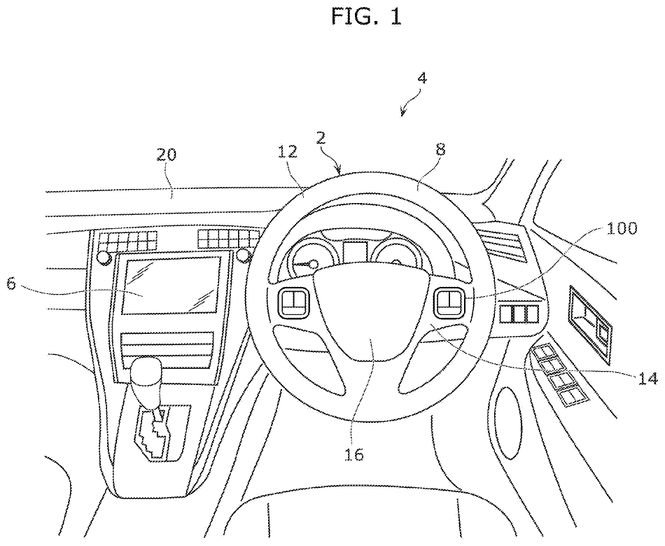

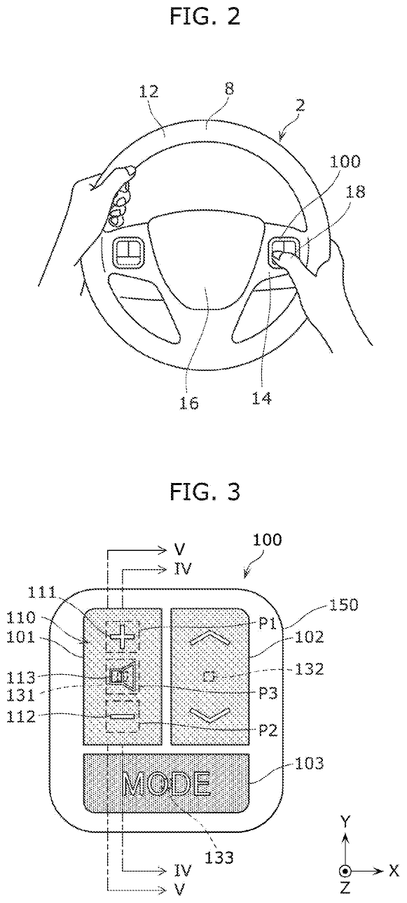

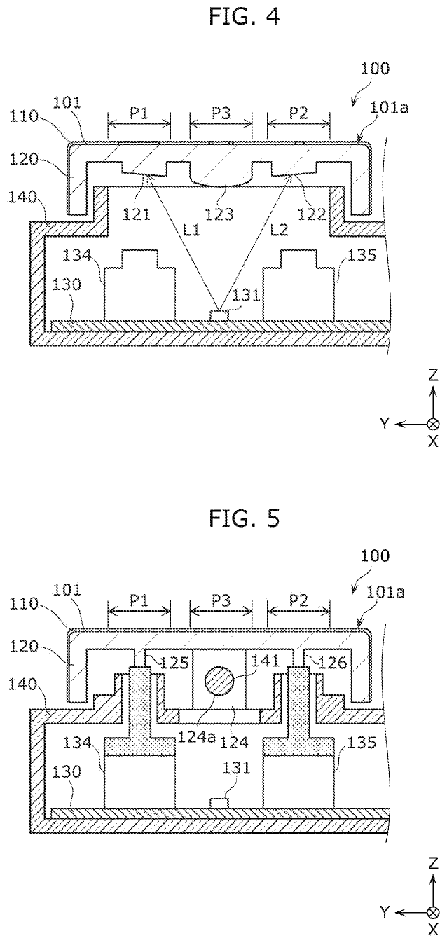

First, the configuration of steering input device 2 according to an embodiment will be described with reference to FIG. 1 and FIG. 2. FIG. 1 illustrates an example of a cabin of a vehicle in which steering input device 2 according to the embodiment is provided. FIG. 2 illustrates a usage example of steering input device 2 according to the embodiment.

In the cabin of automobile 4 (an example of the vehicle) illustrated in FIG. 1, steering input device 2 and on-board device 6 are provided. Steering input device 2 according to the embodiment includes steering wheel 8 and lighting device 100.

Steering wheel 8 is used for steering automobile 4. Steering wheel 8 includes rim 12 that is in a ring shape, spoke 14 that is in a substantially T-shape and integrally formed on the circumferential surface of rim 12, and horn switch cover 16 that covers a horn switch (not illustrated) located on a center portion of spoke 14.

Lighting device 100 is used for operating on-board device 6 and provided on spoke 14 of steering wheel 8, for example. As illustrated in FIG. 2, a driver, that is, a user can operate on-board device 6 by making an input to lighting device 100 with finger 18 (an example of an operating subject) of the right hand holding rim 12. The configuration of lighting device 100 will be described in detail later.

For example, on-board device 6 is an audio device for playing an optical disc such as a compact disc. On-board device 6 is provided in dashboard 20, for example. It should be noted that on-board device 6 is not limited to an audio device and may be an air-conditioner that performs air-conditioning in the cabin, or may be an automotive navigation system.

### (1-2. Configuration of Lighting Device)

Next, the configuration of lighting device 100 according to the embodiment will be described with reference to FIG. 3 to FIG. 5. FIG. 3 is a plan view of the lighting device according to the embodiment as a front-side surface of the lighting device is viewed in a plan view. FIG. 4 is a cross-sectional view along IV-IV of part of the lighting device according to the embodiment in FIG. 3. FIG. 5 is a cross-sectional view along V-V of part of the lighting device according to the embodiment in FIG. 3. In these figures, description will be given on the premise that the front-and-back direction is the Z-axis direction, the up-and-down direction is the Y-axis direction, and the left-and-right direction is the X-axis direction. The X-axis direction, Y-axis direction, and Z-axis direction are directions perpendicular to one another. Moreover, the front side may sometimes be referred to as the Z-axis direction positive side, the back side may sometimes be referred to as the Z-axis direction negative side, the up side may sometimes be referred to as the Y-axis direction positive side, the down side may sometimes be referred to as the Y-axis direction negative side, the right side may sometimes be referred to as the X-axis direction positive side, and the left side may sometimes be referred to as the X-axis direction negative side. Moreover, the positive side in each of the directions is a tip side of each of arrows indicating the directions in the Drawings, and the negative side is opposite to the positive side. It should be noted that the front-and-back direction is the front-and-back direction of lighting device 100, and does not relate to a traveling direction of automobile 4.

In lighting device 100 in FIG. 3, three display parts 101, 102, and 103 as buttons each of which receives an input by a user, three light sources 131, 132, and 133 that are arranged behind three display parts 101, 102, and 103, and outer frame 150 that surrounds display parts 101, 102, and 103 are illustrated. In display part 101, first designs 111 and 112, and second design 113 are provided. First designs 111 and 112 and second design 113 are arranged at mutually different positions on front-side part 110 that includes the front-side surface of display part 101, and have mutually different shapes. First designs 111 and 112 are located on first portions P1 and P2 of front-side part 110 of display part 101, respectively, and second design 113 is located on second portion P3 of front-side part 110. First portions P1 and P2 are part of front-side part 110 and transmit light in the shapes of first designs 111 and 112, respectively. Second portion P3 is part of front-side part 110 and transmits light in the shape of second design 113. Light source 131 located behind display part 101 is located at a position overlapping with second portion P3 as illustrated in FIG. 3, that is, in a plan view of front-side surface 101a. In other words, light source 131 is located at a position different from first portions P1 and P2 (i.e., a position that does not overlap with first portions P1 and P2) in a plan view of front-side surface 101a. It should be noted that although display parts 102 and 103 are also provided with designs, the description for display parts 102 and 103 is omitted.

As illustrated in FIG. 4 and FIG. 5, lighting device 100 includes display part 101, substrate 130, light source 131, and housing 140. Lighting device 100 may further include switches 134 and 135. FIG. 4 is a cross-sectional view of lighting device 100 cut along the Y-Z plane passing through light source 131. FIG. 5 is a cross-sectional view of lighting device 100 cut along the Y-Z plane passing through switches 134 and 135.

As described in FIG. 3, display part 101 transmits forward the light emitted by light source 131 in the shapes of first designs 111 and 112 and second design 113, to thereby display first designs 111 and 112 and second design 113 on front-side surface 101a. Display part 101 includes front-side part 110 including front-side surface 101a, and light guide 120 that has a thickness, is located behind front-side part 110, and is in a plate-like shape, for example. Display part 101 transmits forward the light that has been emitted by light source 131 and entered light guide 120, via front-side part 110. Thus, since display part 101 transmits the light in the shapes of first designs 111 and 112 and second design 113, first designs 111 and 112 and second design 113 are displayed on front-side surface 101a of display part 101.

Front-side part 110 includes first portions P1 and P2 and second portion P3 that transmit light in the shapes of first designs 111 and 112 and second design 113, respectively, as described above. Front-side part 110 includes a light-shielding layer having a light blocking property, and the light-shielding layer includes a light-transmissive portion in the shape of first design 111 at first portion P1. Similarly, the light-shielding layer includes a light-transmissive portion in the shape of first design 112 at first portion P2 and a light-transmissive portion in the shape of second design 113 at second portion P3. It should be noted that each of the light-transmissive portions may be formed of a portion in which the light-shielding layer is not provided, that is, an opening, for example. Moreover, each of the light-transmissive portions may be formed of a single opening or a plurality of openings that are arranged in a corresponding shape of the designs. Furthermore, the opening of each of the light-transmissive portions may be filled with a material having a light transmitting property. The light-shielding layer may be constituted of a coating film or a film having a light blocking property, for example.

Light guide 120 transmits, toward front-side part 110, the light emitted from light source 131 to the back-side surface of light guide 120. As illustrated in FIG. 4, light guide 120 may include two protruding parts 121 and 122 protruding backward. Two protruding parts 121 and 122 are located behind first portions P1 and P2, respectively. In other words, protruding part 121 is opposite to first portion P1 in the Z-axis direction, and protruding part 122 is opposite to first portion P2 in the Z-axis direction. Moreover, protruding parts 121 and 122 are located at positions that do not opposite to light source 131 in the Z-axis direction. In other words, protruding parts 121 and 122 are located at positions different from light source 131 (i.e., positions that do not overlap with light source 131) in a plan view of front-side surface 101a. Therefore, light L1 from light source 131 in a diagonal direction that is inclined with respect to the Z-axis direction is incident on protruding part 121. Similarly, light L2 from light source 131 in a diagonal direction that is inclined with respect to the Z-axis direction is incident on protruding part 122. Each of protruding parts 121 and 122 is formed so that back-side surface thereof is inclined with respect to front-side surface 101a in order to have a thickness that decreases with distance from light source 131 in the Y-axis direction. In other words, light guide 120 includes a portion of which thickness decreases with distance from light source 131. Light guide 120 includes a milky white material, and, for example, includes acrylic resin, polycarbonate resin, or the like that includes a light diffusing agent.

Moreover, light guide 120 may further include protruding part 123 protruding backward. Protruding part 123 is located behind second portion P3. In other words, protruding part 123 is opposite to second portion P3 in the Z-axis direction. Moreover, protruding part 123 is located at a position overlapping with light source 131 in a plan view of front-side surface 101a.

Moreover, as illustrated in FIG. 5, light guide 120 may include plate-like support 124 protruding toward the back side from the central part, in the Y-axis direction, of light guide 120, and bar-like pushers 125 and 126 protruding toward the back side from positions on both sides, in the Y-axis direction, of support 124. Support 124 includes through hole 124a that is in a circular shape penetrating support 124 in the X-axis direction, and support 124 is supported, on housing 140, by columnar shaft 141 that is provided on housing 140 and penetrates through hole 124a. Pushers 125 and 126 are parts for pushing push-type switches 134 and 135, respectively, and are in contact with the upper ends of switches 134 and 135, respectively.

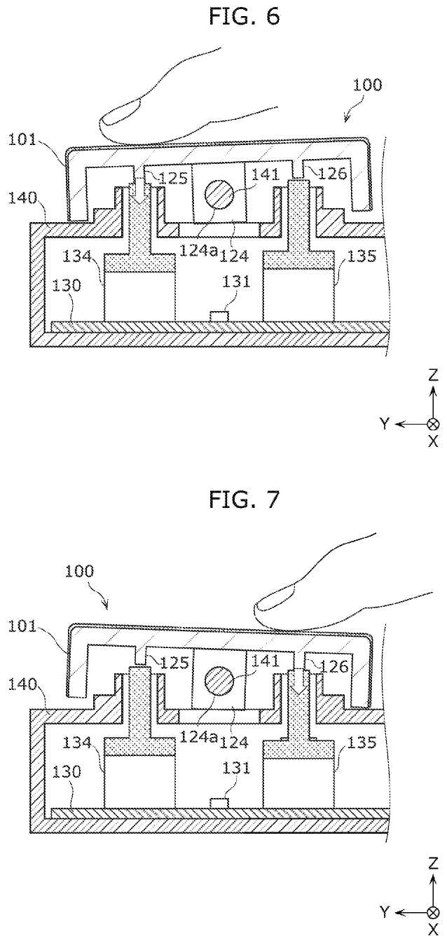

Here, a movement at the time when display part 101 receives an input by a user will be described with reference to FIG. 6 and FIG. 7.

FIG. 6 is a diagram for describing a movement of the display part when a user pushes first portion P1 in which first design 111 is provided. FIG. 7 is a diagram for describing a movement of the display part when a user pushes first portion P2 in which first design 112 is provided. It should be noted that FIG. 6 and FIG. 7 are diagrams for describing a movement of display part 101 in the cross-sectional view of FIG. 5.

As illustrated in FIG. 6, when a user pushes first portion P1 in which first design 111 is provided, display part 101 rotates about through hole 124a, as a shaft, of support 124 of light guide 120 in a direction in which first portion P1 moves toward the back side (the Z-axis direction negative side) and first portion P2 moves toward the front side (the Z-axis direction positive side). Thus, pusher 125 of light guide 120 pushes the tip of switch 134 to turn on switch 134. It should be noted that when the user stops the pushing of first portion P1, the tip of switch 134 is caused to return to the original position by the force of a spring and therefore pusher 125 is pushed back and display part 101 returns to the original posture that is not inclined but horizontal. It should be noted that when the tip of switch 134 returns to the original position, switch 134 is turned off.

As illustrated in FIG. 7, when a user pushes first portion P2 in which first design 112 is provided, display part 101 rotates about through hole 124a, as a shaft, of support 124 of light guide 120 in a direction in which first portion P2 moves toward the back side (the Z-axis direction negative side) and first portion P1 moves toward the front side (the Z-axis direction positive side). Thus, pusher 126 of light guide 120 pushes the tip of switch 135 to turn on switch 135. It should be noted that when the user stops the pushing of first portion P2, the tip of switch 135 is caused to return to the original position by the force of a spring and therefore pusher 126 is pushed back and display part 101 returns to the original posture that is not inclined but horizontal. It should be noted that when the tip of switch 135 returns to the original position, switch 135 is turned off.

Next, description goes back to FIG. 4 and FIG. 5.

Substrate 130 is located behind display part 101, and is a plate-like part that is parallel to the X-Y plane. Electrical parts such as light sources 131, 132, and 133 and switches 134 and 135 are mounted on substrate 130.

As described above, light sources 131, 132, and 133 are arranged behind display parts 101, 102, and 103, respectively, and emit light from behind display parts 101, 102, and 103, respectively. Each of light sources 131, 132, and 133 includes a light emitting diode (LED), for example.

Switches 134 and 135 are arranged behind display part 101, and are push-type switches that are turned on by pushing of display part 101 by a user. When one of switches 134 and 135 is turned on, a control circuit, which is not illustrated in the Drawings, detects that the one of switches 134 and 135 has been turned on and executes the function associated in advance with the one of switches 134 and 135 that has been turned on. For example, when switch 134 is turned on, the control circuit may increase the volume of sound outputted into the cabin from a loudspeaker, which is not illustrated in the Drawings. Moreover, for example, when switch 135 is turned on, the control circuit may decrease the volume of sound outputted into the cabin from the loudspeaker, which is not illustrated in the Drawings. The function that is implemented by the control circuit is not limited to increase or decrease of sound volume and may be forwarding, rewinding, playing, stopping, or the like on a music player, increase or decrease of a set temperature of an air-conditioner, or switching on/off of an air-conditioner.

Housing 140 contains substrate 130 and the electrical parts mounted on substrate 130. Moreover, housing 140 supports display part 101 at its front. Housing 140 includes resin or the like, for example.

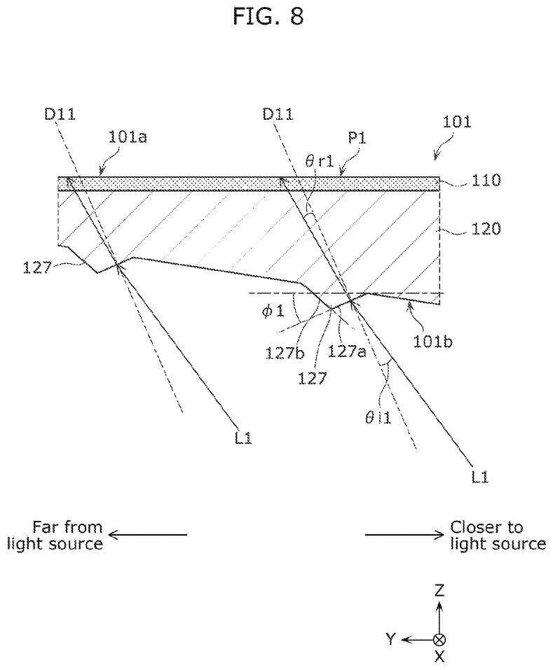

Next, the shape of display part 101 will be described in detail with reference to FIG. 8.

FIG. 8 is an enlarged view of part of protruding part 121 in FIG. 4. It should be noted that FIG. 8 is a schematic view and is not a view in which part of protruding part 121 in FIG. 4 is precisely enlarged.

As illustrated in FIG. 8, protrusions 127 are provided on a surface (hereinafter, referred to as back-side surface 101b) on the back side of light guide 120 of display part 101. Protrusions 127 are provided on back-side surface 101b at positions different in distance from light source 131. For example, protrusions 127 are arranged at a predetermined pitch. It should be noted that, as illustrated in FIG. 8, back-side surface 101b includes, between adjacent two protrusions 127 among protrusions 127, an area in which protrusion 127 is not provided. However, this example is not limiting and the adjacent two protrusions 127 may be provided so that the adjacent two protrusions 127 come into contact with each other. In other words, protrusions 127 may be continuously arranged adjacent to one another. Moreover, a pitch between protrusions 127 may be changed according to distance from light source 131. For example, a pitch between protrusions 127 may be short at a position close to light source 131, and may be long at a position far from light source 131. For example, protrusions 127 may be provided so that a pitch between protrusions 127 increases with distance from light source 131.

Each of protrusions 127 includes light incidence surface 127a on which light L1 from light source 131 is incident at incident angle θi1 of a predetermined angle. Light incidence surface 127a is a surface on the side closer to light source 131, among surfaces included in each of protrusions 127. Incident angle θi1 is an angle formed by normal direction D11 of light incidence surface 127a and the incident direction of light L1. In other words, light incidence surface 127a is provided so that an angle formed by normal direction D11 of light incidence surface 127a and the incident direction of light L1 becomes the predetermined angle. Consequently, light incidence surface 127a is provided so that an angle formed by light incidence surface 127a and front-side surface 101a becomes first angle φ1, for example. A predetermined angle that defines the angle of incident angle θi1 is, for example, less than or equal to one half of the Brewster angle that is defined by a refractive index (absolute refractive index) of light guide 120 and a refractive index (absolute refractive index) of a medium (e.g., air) around light guide 120. It should be noted that protrusions 127 may be in the same shape. Light L1 is incident on light incidence surface 127a and refracted at refraction angle θr1.

Moreover, each of protrusions 127 includes inclined surface 127b that is located on the side away (on the farther side) from light source 131 than light incidence surface 127a is, and light L1 from light source 131 is more difficult to be incident on inclined surface 127b than light incidence surface 127a. Inclined surface 127b may be formed substantially parallel to light L1 to effectively guide light L1 after being incident on inclined surface 127b to the inside of light guide 120 or to reduce the reflection of light L1. It should be noted that the term “substantially parallel” includes ±15° deviation from being parallel, for example.

Moreover, each of protrusions 127 may be in a rib shape extending in a direction intersecting a direction connecting light source 131 and first portion P1, that is, in a direction intersecting the direction of light L1. Specifically, each of protrusions 127 may be in a rib shape extending in the X-axis direction. Each of protrusions 127 may have a length longer than or equal to the width of first design 111 in the X-axis direction, for example. Accordingly, the light emitted to light guide 120 can efficiently enter light guide 120 from a light incidence surface having the length of the rib shape, and can be efficiently transmitted to an opening in the shape of first design 111.

### 2. Advantageous Effects and the Like

In lighting device 100 according to the present embodiment, since protrusion 127 is provided on back-side surface 101b of light guide 120, incident angle θi1 of the light incident on light incidence surface 127a of light guide 120 can be smaller than that of the light incident on back-side surface 101b. Therefore, an amount of light that is reflected off back-side surface 101b of light guide 120 can be reduced, and an amount of light that enters light guide 120 can be uniformed regardless of distance from light source 131. Moreover, since the light that has entered light guide 120 is refracted at a small angle with respect to the front-side surface of light guide 120, the light that has entered light guide 120 becomes more likely to be diffused inside light guide 120. Accordingly, the light transmitted through light guide 120 to front-side part 110 can be prevented from being transmitted more intensively at a position close to light source 131. Thus, luminance unevenness in a design can be effectively reduced.

Moreover, in lighting device 100 according to the present embodiment, the predetermined angle is less than or equal to one half of the Brewster angle that is defined by a refractive index of light guide 120 and a refractive index of a medium around light guide 120. Accordingly, light emitted to light guide 120 can efficiently enter light guide 120.

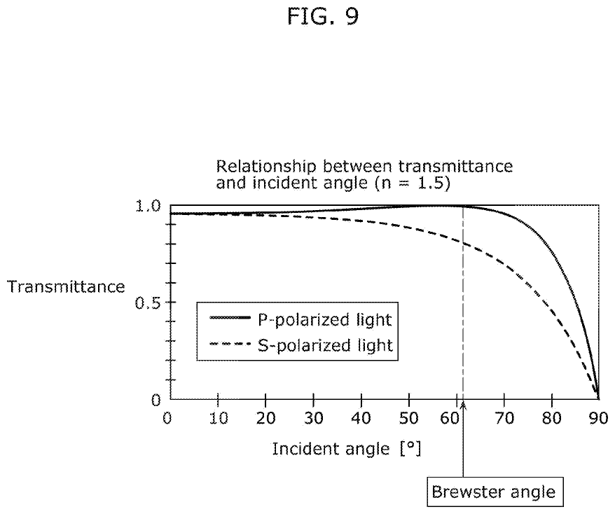

FIG. 9 is a graph showing a relationship between transmittance of light through a light guide having a refractive index of 1.5 and incident angle. In FIG. 9, the solid line represents p-polarized light and the broken line represents s-polarized light.

As illustrated in FIG. 9, the Brewster angle is an incident angle of light when the transmittance of p-polarized light becomes 1.0, that is, when the reflectance of p-polarized light becomes 0. For example, when a material having a refractive index of 1.5 is used, the Brewster angle is approximately 61°.

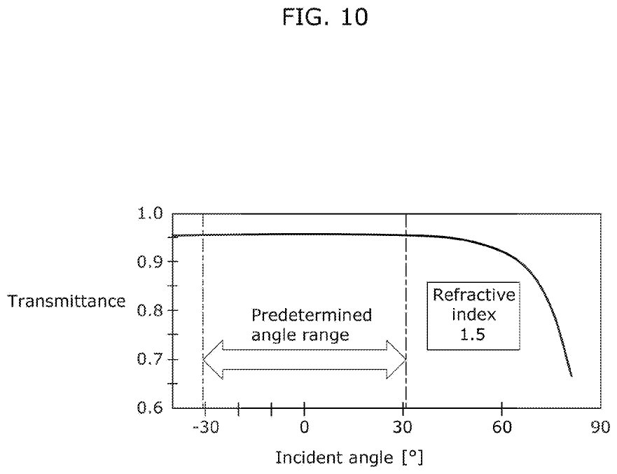

FIG. 10 is a graph showing a relationship between transmittance of light through the light guide having a refractive index of 1.5 and incident angle with respect to a light incidence surface of the light guide.

As illustrated in FIG. 10, it is found that transmittance is more than 0.95 when an incident angle is within the range of from approximately −30° to approximately 30°. In other words, it is found that transmittance is improved by setting an incident angle to be within the angle range of less than or equal to one half of the Brewster angle. It should be noted that transmittance of more than 0.95 indicates that an amount of light reflected off a light incidence surface has been reduced to less than 0.05.

Moreover, in lighting device 100 according to the present embodiment, on back-side surface 101b of light guide 120, protrusions 127 are provided at positions different in distance from light source 131. Accordingly, even if the size of each of protrusions 127 is small, light incidence surface 127a on which light is incident at the predetermined angle can be provided to each of protrusions 127 in a wide area of back-side surface 101b. Thus, lighting device 100 can be made small.

Moreover, in lighting device 100 according to the present embodiment, front-side part 110 further includes second portion P3 through which light is transmitted in the shape of second design 113. Light source 131 is located at a position overlapping with second portion P3 of front-side part 110 in a plan view of front-side surface 101a.

Accordingly, when designs 111, 112, and 113 are displayed by a single light source 131 and second design 113 is located at a position opposite to light source 131 in the Z-axis direction, first designs 111 and 112 receive the light emitted diagonally from light source 131. Even when designs 111, 112, and 113 are displayed by a single light source 131 as described, both reduction of the number of light sources 131 and reduction of luminance unevenness can be achieved since luminance unevenness in first designs 111 and 112 can be reduced.

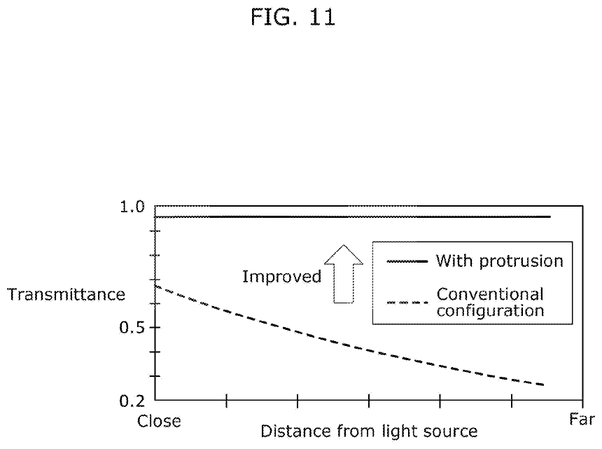

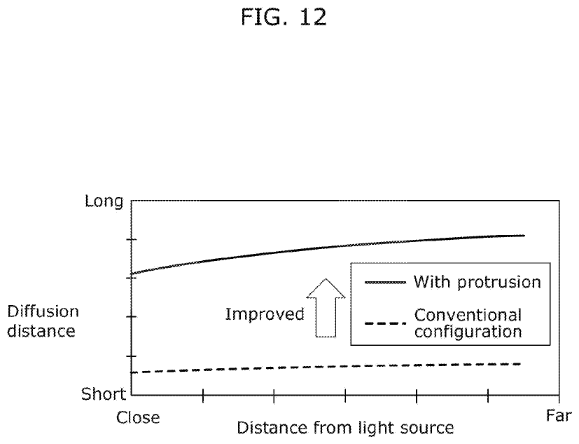

FIG. 11 is a graph showing a relationship between distance from a light source and transmittance of light through a light guide in a conventional configuration without a protrusion, and a relationship between distance from a light source and transmittance of light through a light guide in the configuration of the present disclosure with protrusions. FIG. 12 is a graph showing a relationship between distance from the light source and diffusion distance of light in the light guide in the conventional configuration without a protrusion, and a relationship between distance from the light source and diffusion distance of light in the light guide in the configuration of the present disclosure with protrusions. It should be noted that diffusion distance indicates the length of a path through which light passes inside light guide 120 from when the light enters light guide 120 to when the light exits from light guide 120.

As illustrated in FIG. 11, in the conventional configuration, transmittance of light through the light guide is less than 0.7 at any positions regardless of distance from the light source, and it is found that the difference of approximately 0.4 exists between the transmission of light at the closest position to the light source and the transmission of light at the farthest position from the light source. On the other hand, in the configuration of the present disclosure, transmittance of light through the light guide is more than 0.95 at any positions regardless of distance from the light source. Accordingly, it is found that light efficiently enters the light guide and transmittance is improved.

Moreover, as illustrated in FIG. 12, it is found that diffusion distance is increased at any positions regardless of distance from the light source in the configuration of the present disclosure than that in the conventional configuration. Diffusion distance becomes the shortest when the light that has entered the light guide is transmitted in a direction perpendicular to a front-side surface of the light guide, and becomes longer with an increase in an angle formed by a direction in which the light that has entered the light guide is transmitted and the direction perpendicular to the front-side surface of the light guide. Accordingly, it is found that the light that has entered the light guide is effectively diffused and diffusion distance is improved.

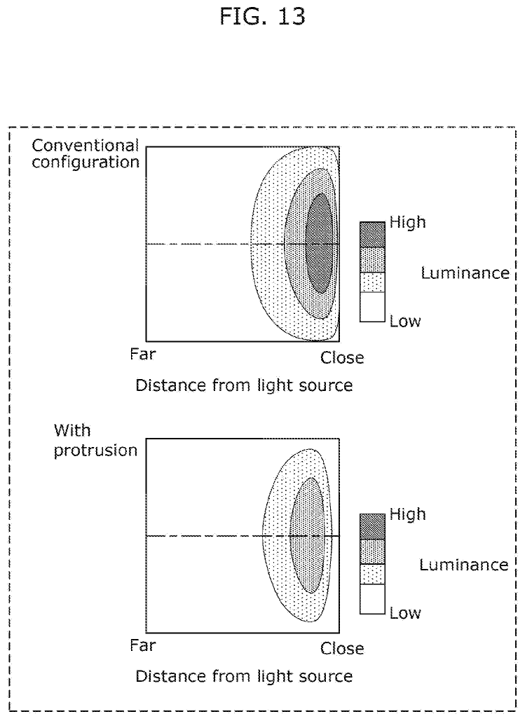

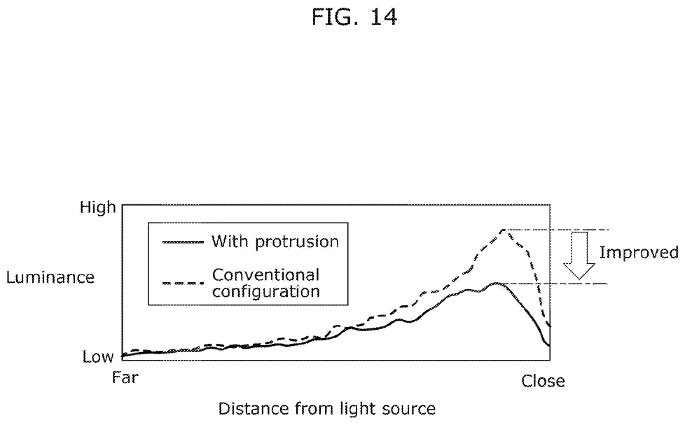

FIG. 13 illustrates a luminance distribution on the front-side surface of the light guide in the conventional configuration without a protrusion and a luminance distribution on the front-side surface of the light guide in the configuration of the present disclosure with protrusions. FIG. 14 is a graph showing a relationship between distance from the light source and luminance on the front-side surface of the light guide in the conventional configuration without a protrusion, and a relationship between distance from the light source and luminance on the front-side surface of the light guide in the configuration of the present disclosure with protrusions. It should be noted that the graphs in FIG. 13 and FIG. 14 are results obtained by a simulation in which a side surface of protruding part 121 on the side closer to light source 131 is assumed to be a blackbody (an ideal object that completely absorbs light).

As illustrated in FIG. 13 and FIG. 14, it is found that the difference between the maximum value and the minimum value of luminance distribution is smaller in the configuration of the present disclosure with protrusions than that in the conventional configuration. Accordingly, it is found that luminance uniformity is improved.

### 3. Variation

(1)

Although the shapes of protrusions 127 provided on light guide 120 of display part 101 of lighting device 100 according to the above embodiment are identical to each other, the shapes are not limited to this example and may be different from each other.

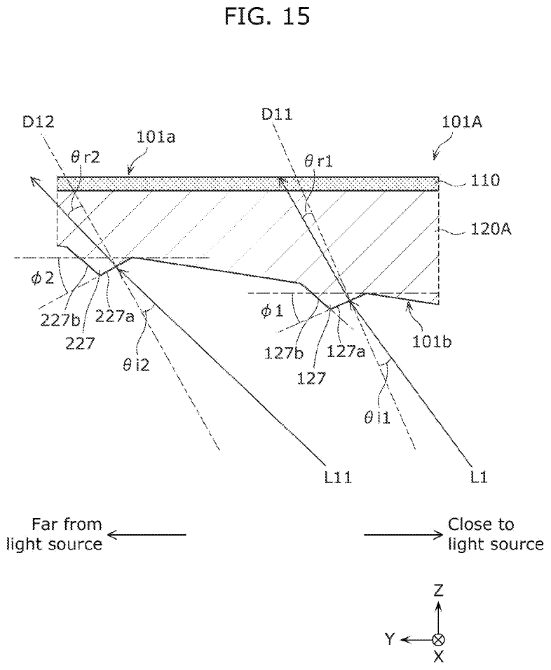

FIG. 15 is an enlarged view of part of a part, which corresponds to protruding part 121 in FIG. 4, of display part 101A of a lighting device according to a variation.

As illustrated in FIG. 15, protrusions 127 and 227 provided on back-side surface 101b of light guide 120A of display part 101A are in different shapes. In the above embodiment, light L1 from light source 131 to each of protrusions 127 is assumed to be incident on each of protrusions 127 in a direction parallel to each other. However, in the variation, it is taken into consideration that the light from light source 131 is incident on a protrusion located farther from light source 131 at a larger incident angle, that is, in a direction closer to the horizontal direction (i.e., Y-axis direction) in FIG. 15.

Protrusions 127 and 227 include first protrusion 127 and second protrusion 227 that is located farther from light source 131 than first protrusion 127 is. First protrusion 127 includes light incidence surface 127a on the side closer to light source 131 and inclined surface 127b on the side farther from light source 131. Second protrusion 227 includes light incidence surface 227a on the side closer to light source 131 and inclined surface 227b on the side farther from light source 131. Similar to the above embodiment, light incidence surface 127a is provided so that incident angle θi1 formed by normal direction D11 of light incidence surface 127a and the incident direction of light L1 becomes a predetermined angle. For example, light incidence surface 127a is provided so that an angle formed by light incidence surface 127a and front-side surface 101a becomes first angle φ1. It should be noted that light L1 is incident on light incidence surface 127a and refracted at refraction angle θr1.

Moreover, light incidence surface 227a is provided so that incident angle θi2 formed by normal direction D12 of light incidence surface 227a and the incident direction of light L11 becomes a predetermined angle. For example, light incidence surface 227a is provided so that an angle formed by light incidence surface 227a and front-side surface 101a becomes second angle φ2. Light L11 is incident on light incidence surface 227a and refracted at refraction angle θr2.

Here, taking into consideration that the light from light source 131 is incident on a protrusion located farther from light source 131 at a larger incident angle, that is, in a direction closer to the horizontal direction (i.e., Y-axis direction) in FIG. 15, first angle φ1 is set to be smaller than second angle φ2. In other words, by individually changing angles of light incidence surfaces 127a and 227a of protrusions 127 and 227 with respect to front-side surface 101a according to the positions of protrusions 127 and 227, the light emitted by light source 131 can efficiently enter light guide 120A. Moreover, inclined surface 127b and inclined surface 227b may be formed substantially parallel to the traveling direction of light L1 and the traveling direction of light L11, respectively. Accordingly, reflection of light L1 at inclined surface 127b and reflection of light L11 at inclined surface 227b can be reduced.

It should be noted that, in the variation as well, similar to the above embodiment, the predetermined angle is, for example, less than or equal to one half of the Brewster angle that is defined by a refractive index (absolute refractive index) of light guide 120A and a refractive index (absolute refractive index) of a medium (e.g., air) around light guide 120A.

(2)

Although each of light guide 120 of lighting device 100 according to the above embodiment and light guide 120A according to (1) of the variation has protrusions 127 and 227, the example is not limiting and a single protrusion having a size that can cover the width of a design may be provided. Although the size of a light guide in this case is assumed to be bigger than the size of each of light guides 120 and 120A, the same advantageous effect as in the above embodiment can be obtained even when a single protrusion is provided.

Hereinabove, although the lighting device according to one or more aspects of the present disclosure has been described based on the embodiment, the present disclosure is not limited to the embodiment. Forms obtained by various modifications to the embodiment that can be conceived by a person of skill in the art as well as forms realized by combining constituent elements in different embodiments are included within the scope of the one or more aspects of the present disclosure as long as these do not depart from the essence of the present disclosure.

### Further Information about Technical Background to this Application

The disclosures of the following patent applications including specification, drawings, and claims are incorporated herein by reference in their entirety: PCT International Application No. PCT/JP2021/044873 filed on Dec. 7, 2021, designating the United States of America, which is based on and claims priority of Japanese Patent Application No. 2021-037617 filed on Mar. 9, 2021.

### INDUSTRIAL APPLICABILITY

The present disclosure is applicable as a lighting device that can effectively reduce luminance unevenness in a design.

1. A lighting device comprising:
a light source; and
a display part that displays a first design on a front-side surface of the display part by transmitting light forward in a shape of the first design, the light being emitted by the light source, wherein
the display part includes:
a front-side part that includes the front-side surface and a first portion that transmits light in the shape of the first design; and
a light guide that is located behind the front-side part and transmits the light from the light source toward the front-side part,
the light source is located at a position different from the first portion of the front-side part in a plan view of the front-side surface,
the light guide includes a portion that is located at a position different from the light source and overlapping with the first portion of the front-side part in the plan view of the front-side surface, the portion having a thickness that decreases with distance from the light source, and
the light guide includes, on a back-side surface of the portion having the thickness that decreases with distance from the light source, a protrusion including a light incidence surface on which the light from the light source is incident at an incident angle that is a predetermined angle.

2. The lighting device according to claim 1, wherein
the predetermined angle is less than or equal to one half of a Brewster angle that is defined by a refractive index of the light guide and a refractive index of a medium around the light guide.

3. The lighting device according to claim 1, wherein
the protrusion is in a shape extending in a direction intersecting a direction connecting the light source and the first portion.

4. The lighting device according to claim 1, wherein
the light guide includes, on the back-side surface, a plurality of protrusions disposed at positions different in distance from the light source, each of the plurality of protrusions being the protrusion.

5. The lighting device according to claim 4, wherein
the plurality of protrusions include a first protrusion and a second protrusion that is located farther from the light source than the first protrusion is, and
a first angle of a first light incidence surface of the first protrusion with respect to the front-side surface is smaller than a second angle of a second light incidence surface of the second protrusion with respect to the front-side surface.

6. The lighting device according to claim 4, wherein
the plurality of protrusions are arranged at a predetermined pitch.

7. The lighting device according to claim 4, wherein
the plurality of protrusions are continuously arranged adjacent to one another.

8. The lighting device according to claim 4, wherein
the predetermined pitch between the plurality of protrusions varies according to distance from the light source.

9. The lighting device according to claim 8, wherein
the predetermined pitch between the plurality of protrusions increases with distance from the light source.

10. The lighting device according to claim 1, wherein
the light guide includes a protruding part protruding backward,
the protruding part is located behind the first portion of the front-side part,
the protruding part has a thickness that decreases with distance from the light source, and
the protruding part includes, on a back-side surface of the protruding part, the protrusion including the light incidence surface on which the light from the light source is incident at the incident angle that is the predetermined angle.

11. The lighting device according to claim 1, wherein
the front-side part further includes a second portion that transmits light in a shape of a second design, and
the light source is located at a position overlapping with the second portion of the front-side part in the plan view of the front-side surface.

12. The lighting device according to claim 1, wherein
the first portion of the front-side part includes a third portion and a fourth portion, and
the light source is located at a position different from the third portion and the fourth portion of the front-side part in the plan view of the front-side surface.
